(19) United States
(12) Patent Application Publication
(10) Pub. No.: US 2009/0008045 A1
(43) Pub. Date: Jan. 8, 2009

(54) Shading Device for a Light-Permeable Window, In Particular for Motor Vehicles

(75) Inventor: Marc Serneels, Les Essarts (FR)

Correspondence Address: DICKINSON WRIGHT PLLC, 1875 Eye Street, NW, Suite 1200, WASHINGTON, DC, 20006, US

(73) Assignee: WEBASTO AG, Strockdorf (DD)

(21) Appl. No.: 12/280,258

(22) PCT Filed: Feb. 22, 2007
(86) PCT No.: PCT/DE2007/000334

§ 371 Date: Aug. 25, 2008

(30) Foreign Application Priority Data
Feb. 22, 2006 (FR) 06/01520

(51) Int. Cl. E06B 9/56; B60J 9/00

(52) U.S. Cl. 160/309; 296/1.07

(57) ABSTRACT

The present invention relates to a shading device (1) of a light-permeable window, which comprises a canvas (10), which is movably mounted for displacement, and at least one transverse reinforcement (50), which is connected fixedly to the canvas (10). The invention is worthy of note in so far as each transverse reinforcement (50) has an inner receptacle (51) which, firstly, is open in the longitudinal direction via a gap (52), the width of which is smaller than that of the abovementioned inner receptacle (51), and, secondly, is suitable for accommodating a fold of the canvas (11), which fold is arranged in the transverse direction starting from the canvas (10) and is provided with a thickened part (12), the cross section of which is larger than the width of the abovementioned gap (12).

The present invention relates to a device which is intended to shade at least one light-permeable window by means of a blind.

The invention is used particularly advantageously, but not exclusively, in the field of motor vehicles.

Nowadays, an increasing number of roofs of motor vehicles are provided with light-permeable, i.e. transparent or translucent, windows. Generally, these roofs are either a sliding roof system, the movable window thereof being made of glass, or a fixed window made of glass, which directly forms a more or less large part of the roof liner.

Irrespective of the embodiment under consideration, in practice this type of more or less transparent window is used systematically in combination with a light shading device, which is suitable for being extended parallel to the inner face of the glass window. The object of such a device is to prevent light rays which penetrate through the glass window, from spreading inside the vehicle interior. The object is thus naturally to limit the greenhouse effect in the interior of the motor vehicle, in particular on days with strong solar radiation.

In the shading devices according to the prior art known per se, two devices stand out which fulfill their purpose by the use of a more or less transparent canvas blind, which is movably mounted for displacement relative to a region to be shaded between a received position and an extended position. Generally, the two opposing ends of the canvas are respectively fixedly connected to a rolling tube arranged at a distance from the region to be shaded and movably mounted for axial rotation and a drawbar movably mounted for displacement along the aforementioned region to be shaded. The whole assembly is designed such that the canvas is rolled up in the received position onto a rolling tube and in that the aforementioned canvas extends in the extended position below the region to be shaded.

Moreover, it may occasionally prove advantageous for the canvas to be able to be supported in the longitudinal direction and/or in the transverse direction in the region to be shaded. This is, in particular, the case when the window to be shaded has large dimensions, in order to avoid any hammock effect as a result of the dead weight of the canvas and thus to guarantee the efficiency and the purely aesthetic appearance of the shading device. This is, however, also the case when the window to be shaded has a significant curvature, so as to be adapted in the best possible manner to the inner face of the aforementioned window and thus to optimize the use of space in the interior of the vehicle.

Irrespective thereof, for the design of such a support it is known to provide the canvas with one or more transverse reinforcements, which are relatively rigid and furthermore are suitable for sliding between two guide rails respectively arranged in the longitudinal direction on both sides of the region to be shaded. The connection between each transverse reinforcement and the canvas is carried out generally by means of a cover, i.e. a woven fabric strip, which is fastened by its two side edges transversely over the aforementioned canvas such that an internal space is created, which is able to receive freely the aforementioned transverse reinforcement. The actual fastening of the edges of each cover to the canvas generally takes place by welding, bonding and/or stitching.

This type of shading device comprising a blind and transverse reinforcements has, however, the drawback of having a visual appearance which is insufficiently enhancing, in particular with regard to the specifications for luxury vehicles. The fastening of the two side edges of each cover to the rear face of the canvas actually tends to provide the front face of the aforementioned canvas, i.e. the surface to be seen by the user, with marks. In practice, these marks are manifested by two unattractive linear tracks which correspond to the contact regions and fastening regions between the woven fabric strips of the cover and the canvas.

Accordingly, the technical problem to be solved by the subject-matter of the present invention is to propose a shading device of a light-permeable window which comprises a canvas, which is movably mounted for displacement between an extended position in which it extends below a region to be shaded, and a received position in which it is arranged at a distance from the aforementioned region to be shaded, and at least one transverse reinforcement, which is fixedly connected to the canvas and the ends of which are respectively suitable for sliding along the two guide rails arranged on both sides of the region to be shaded in the longitudinal direction, the shading device making it possible to avoid the problems according to the prior art, in particular by a considerably more attractive appearance being provided.

The solution according to the invention of the technical problem set forth above is that each transverse reinforcement has an inner receptacle which, on the one hand, is open in the longitudinal direction via a gap, the width thereof being smaller than the aforementioned inner receptacle and, on the other hand, is suitable for receiving a fold of the canvas which, starting from the canvas, is arranged in the transverse direction and is provided with a thickened part, the cross section thereof being greater than the width of the aforementioned gap.

It should be noted that in the entirety of this description the expression “transparent” is understood in the widest sense. Thus a transparent window generally denotes any light-permeable element, i.e. a completely transparent or more or less translucent element.

The invention thus defined provides the advantage that, for each connection with a transverse reinforcement, only one single transverse mark is produced on the front face of the canvas. This mark is a line which determines the appearance of the space which defines the two parts of the canvas located on both sides of the fold of the canvas.

The present invention also relates to the features which are revealed from the following description and which may be considered individually or in all possible technical combinations.

This description provided as a non-limiting example makes it easier to understand what the invention consists of and how it may be implemented. It is, moreover, provided by referring to the accompanying drawings, in which:

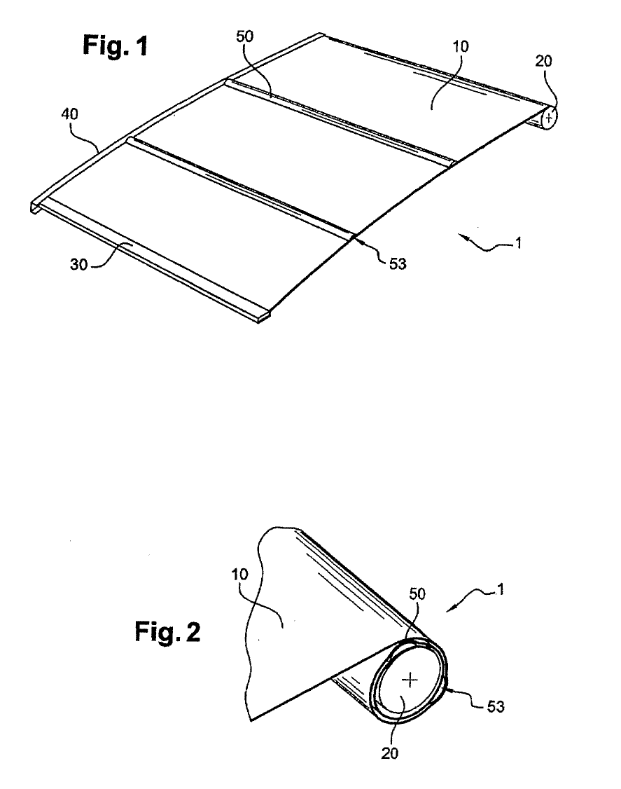

FIG. 1 shows a shading device according to the invention, the canvas being shown in the extended position;

FIG. 2 is a view similar to FIG. 1, the canvas however being located in the received position;

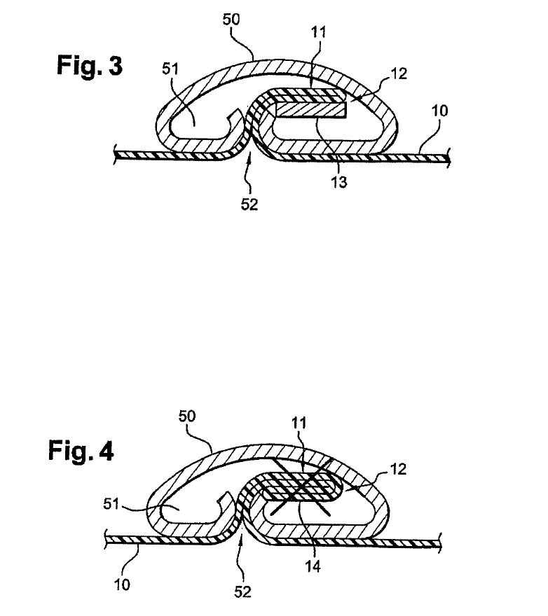

FIG. 3 shows a connection between the transverse reinforcement and the canvas which corresponds to a first embodiment of the invention;

FIG. 4 illustrates a connection between the transverse reinforcement and the canvas, which in turn corresponds to a second embodiment of the invention.

For reasons of clarity, components which are the same are respectively denoted by identical reference numerals. Moreover, only the components essential for the understanding of the invention are shown, in a manner which is also not to scale and only schematic.

FIGS. 1 and 2 show a shading device 1 which is intended to be fixedly connected inside the passenger interior of a motor vehicle, and which has the object of shading a fixedly installed glass window, which forms the roof liner in the upper part of the bodywork of the aforementioned vehicle.

As may be seen from the schematic views, the shading device 1 is of the roller blind type. It is actually formed from a canvas 10, the two opposing ends thereof respectively being fixedly connected, on the one hand, to a rolling tube 20 arranged at a distance from the region to be shaded and movably mounted for axial rotation and, on the other hand, to a drawbar 30, the ends thereof being movably mounted for the sliding movement respectively along the two sliding rails 40 which are arranged on both sides of the aforementioned region to be shaded. It is noteworthy that, for simple reasons of clarity, only the guide rail 40 located to the rear has been shown.

In order to be able to be extended parallel to the inner face of the glass window, the canvas 10 is, moreover, movably mounted for displacement between a received position in which it is rolled up about its rolling tube 20 (FIG. 2) and an extended position in which it extends below the region to be shaded (FIG. 1).

FIGS. 1 and 2 also show that the shading device 1 is, moreover, provided with two transverse reinforcements 50, which are fixedly connected to the canvas 10 and are slidably mounted along the rails 40 which are already used for guiding the displacement of the drawbar 30. In this embodiment, the ends of each transverse reinforcement 50 are provided with conventional skids which, for reasons of clarity, are not shown again but which are respectively suitable for sliding along each guide rail 40.

According to the subject-matter of the present invention, each transverse reinforcement 50 is provided with an inner receptacle 51, which is open longitudinally via a gap 52, the width thereof being smaller than that of the aforementioned inner receptacle 51. The whole assembly is, moreover, arranged and dimensioned such that the inner receptacle 51 is able to receive a fold of the canvas 11, which is arranged in the transverse direction, level with the canvas 10 and is provided with a thickened part 12 which extends over the entire length of the fold of the canvas 11 and has a larger cross section relative to the width of the gap 52.

It should be noted that the transverse reinforcements 50 which are fixedly connected to the canvas 10 are, on the one hand, correspondingly able to slide therewith, level with the region to be shaded (FIG. 1) and, on the other hand, to be rolled up therewith around a rolling tube 20 (FIG. 2).

According to a particularity of the invention, each inner receptacle 51 is, moreover, open axially, level with at least one of the ends of the transverse reinforcement 50 via an opening 53, which allows the fold of the canvas 11 to be passed through with its thickened part 12, the aforementioned opening 53 being connected to the gap 52.

In other words, this means that at least one of the two ends of each transverse reinforcement 50 is provided with an opening 53 which, on the one hand, is connected to the inner receptacle 51 as well as the gap 52 and, on the other hand, is suitable for allowing the insertion or the removal of the fold of the canvas 11 provided with its thickened part 12.

In a particularly advantageous manner, each inner receptacle 51 has a portion which is able to block the thickened part 12 of the fold of the canvas 11 by displacement and namely in all directions apart from that which serves for inserting or removing the aforementioned thickened part 12 in the aforementioned inner receptacle 51.

The fixing of the thickened part 12 in the inside of the inner receptacle 51 is primarily intended to avoid the occurrence of play and thus any problem of vibration which would constitute a source of noise.

According to a further advantageous feature of the invention, the inner receptacle 51 of each transverse reinforcement 50 may have a shape which is substantially complementary to that of the thickened part 12 of the corresponding fold of the canvas 11.

The inner receptacle 51 may actually be dimensioned such that it receives in the best possible manner the thickened part 12, i.e. to offer optimal compactness, at the same time the blocking function being efficiently ensured.

FIG. 3 shows a first type of connection between the transverse reinforcement 50 and the canvas 10 which corresponds to the present invention.

In this first embodiment, the thickened part 12 of the fold of the canvas 11 is formed by a locking element 13 which is fixedly connected to the outer face of the aforementioned fold of the canvas 11.

It is understood that, in theory, the locking element 13 could form in the same manner an integral component of the fold of the canvas 11, such as for example a projection which in comparison with the outer surface of the fold of the canvas 11 forms a bead or, as in the present case, is formed by an attached element which is fixedly connected to the rear face of the fold of the canvas 11 by means of any fastening technique known per se.

According to a particularity of the aforementioned first embodiment, the locking element 13 extends transversely over the entire width of the canvas 10, i.e. over the entire length of the fold of the canvas 11.

In this embodiment, in practice the locking element 13 is formed by a planar element made of thermoplastic material, which is fastened in the transverse direction to the rear face of the fold of the canvas 11, more specifically to the outer face of the fold of the canvas 11.

FIG. 4 shows, on the other hand, a second type of connection between the transverse reinforcement 50 and the canvas 10, which also corresponds to the present invention.

In this second embodiment, the thickened part 12 of the fold of the canvas 11 is formed by a bead 14, which is formed by compacting and/or rolling up the aforementioned fold of the canvas 11.

It is emphasized here that the concept of a bead 14 indirectly implies that the different foldings of the folds of the canvas 11 are joined to one another so that they form an inseparable whole. Relative to this, moreover, it should be noted that the cross to be seen in FIG. 4, symbolizes the nature of the fixed connection of the different foldings of the fold of the canvas 11. Any fastening technique known per se may also be used here.

It is, however, also to be noted that in theory the bead 14 may be formed by any manner of overlapping the fold of the canvas 11, naturally with the provision that this provides an additional thickening which is able to form a thickened part 12 as defined in the invention.

According to a particularity of the aforementioned second embodiment, the bead 14 is arranged in the transverse direction over the entire width of the canvas 10, i.e. over the entire length of the fold of the canvas 11.

Similar to the example shown in FIG. 4 and/or according to a first variant of the aforementioned second embodiment, the bead 14 is formed by compacting and/or folding up the distal part of the fold of the canvas 11, the cross in this case symbolizing a stitched connection of the two folds of the folding.

It is noteworthy that any number of folds forming the bead 14 may, a priori, be selected. It is accordingly possible in the example to provide only one single folding or, however, a plurality of folds arranged in a sequence of parallel layers.

According to a second variant, not shown, of the second embodiment, however, the bead 14 may also be formed by folding up the distal part of the fold of the canvas.

In a similar manner to that which has been disclosed above, any number of windings forming the bead 14 may, a priori, be selected.

Naturally, the invention relates quite generally to any motor vehicle which comprises at least one shading device 1 according to the above description.

1. A shading device of a light-permeable window which comprises a canvas, which is movably mounted for displacement between an extended position in which it extends below a region to be shaded, and a received position in which it is arranged at a distance from the aforementioned region to be shaded, and at least one transverse reinforcement, which is fixedly connected to the canvas and the ends of which are respectively suitable for sliding along the two guide rails arranged on both sides of the region to be shaded in the longitudinal direction, characterized in that each transverse reinforcement has an inner receptacle, which, on the one hand, is open in the longitudinal direction via a gap, the width thereof being smaller than the aforementioned inner receptacle and, on the other hand, is suitable for receiving a fold of the canvas which, starting from the canvas, is arranged in the transverse direction and is provided with a thickened part, the cross section thereof being greater than the width of the aforementioned gap.

2. The shading device of claim 1, characterized in that the inner receptacle is, moreover, open axially, level with at least one of the ends of the transverse reinforcement via an opening, which allows the fold of the canvas to be passed through with its thickened part, the aforementioned opening being connected to the gap.

3. The shading device of claim 1, characterized in that the inner receptacle of the transverse reinforcement has a portion which is able to block the thickened part of the fold of the canvas by displacement, and namely in all directions apart from that which serves for inserting or removing the aforementioned thickened part in the aforementioned inner receptacle.

4. The shading device of claim 1, characterized in that the inner receptacle of the transverse reinforcement has a shape which is substantially complementary to that of the thickened part of the fold of the canvas.

5. The shading device of claim 1, characterized in that the thickened part of the fold of the canvas is formed by a locking element, which is fixedly connected to the outer face of the aforementioned fold of the canvas.

6. The shading device of claim 5, characterized in that the locking element extends transversely over the entire width of the canvas.

7. The shading device of claim 5, characterized in that the locking element is formed by a planar element which is fastened in the transverse direction to the rear face of the fold of the canvas.

8. The shading device of claim 1, characterized in that the thickened part of the fold of the canvas is formed by a bead, which is formed by rolling up the aforementioned fold of the canvas.

9. The shading device of claim 8, characterized in that the bead is arranged in the transverse direction over the entire width of the canvas.

10. The shading device of claim 8, characterized in that the bead is formed by compacting and/or folding up the distal part of the fold of the canvas.

11. The shading device of claim 8, characterized in that the bead is formed by folding up the distal part of the fold of the canvas.

12. A motor vehicle, characterized in that it comprises at least one shading device of claim 1.
